(19) United States
(12) Patent Application Publication
(10) Pub. No.: US 2006/0037674 A1
(43) Pub. Date: Feb. 23, 2006

(54) Laminate for HDD Suspension With the use of Thin Copper Foil and Method for Manufacturing the same

(76) Inventors: Kazuto Okamura, Chiba (JP); Kazunori Ohmizo, Chiba (JP); Takaki Suzuki, Chiba (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/534,249

(22) PCT Filed: Nov. 25, 2003
(86) PCT No.: PCT/JP03/14989

§ 371 Date: May 10, 2005

(30) Foreign Application Priority Data
Nov. 26, 2002 (JP) 2002-342457

(51) Int. Cl. B32B 15/08; C21D 1/70

(52) U.S. Cl. 148/537; 428/458

(57) ABSTRACT

The invention relates to a substrate for HDD suspension. A laminate for HDD suspension comprises a stainless steel layer, a polyimide resin layer, and a conductor layer. The conductor layer is composed of a copper or copper alloy foil having a thickness of 14 μm or less, a tensile strength of 400 MPa, and a conductance of 65% or more. A suspension formed of such a laminate facilitates the control of the flying height of the slider of the suspension essential to great progress of the technology for higher capacity of HDDs, facilitates the impedance control improves the tension rate, reduces the loss of electric signal, facilitates machining of the shape of the flying lead, and provides durability.

### FIELD OF TECHNOLOGY

This invention relates to a laminate for HDD suspension and to a method for manufacturing the same and, more particularly, to a laminate for HDD suspension with the use of a thin copper foil as a conductor layer and a method for manufacturing the same.

### BACKGROUND TECHNOLOGY

Following a progress in the technology to increase the capacity of hard disk drives hereinafter referred to as HDDs), suspensions to be mounted on HDDs have undergone a change in type and suspensions of the conventional wire type have largely been replaced by suspensions of the integrated type in which a suspension is attached to a wiring board to stabilize the flying height and positional accuracy relative to the memory medium or the disk. There are three types of technologies for manufacturing suspensions of the integrated type: flex suspension assembly (FSA) which processes a flexible printed circuit and attaches it to a suspension with an adhesive; circuit integrated suspension (CIS) which processes an amic acid or a precursor of polyimide resin into a prescribed shape, imidizes the amic acid shape and plating the resulting polyimide shape to form wiring; and trace suspension assembly (TSA) which processes a laminate consisting of a stainless steel foil, a polyimide resin and a copper foil into a prescribed shape by etching.

The FSA technology is easy to apply and inexpensive, but the use of an adhesive for attachment adversely affects the positional accuracy of a junction with a terminal and this technology is said to be unable to cope with the situation where wiring becomes still finer in the future. The CIS technology has advantages in that it shows excellent dimensional accuracy as it directly forms wiring on polyimide by plating and it uses pure copper for easy control of electrical properties; however, this technology faces problems such as a necessity of an extra step for removal of polyimide resin by laser in fabrication of a shape called flying lead for singly forming wiring, incapability of fabricating wiring by bending because of weak wiring strength, and a common occurrence of wire breakage due to air disturbance, vibration and contact during passing. The FSA technology is capable of forming a flying lead easily by laminating a copper foil of high strength and finds wide use because of its higher degree of freedom in shape fabrication, relatively low cost and good dimensional accuracy.

In WO98/08216 is disclosed a laminate for HDD suspension prepared by successively forming a polyimide resin layer and a conductor layer on a stainless steel substrate. This document contains a description specifying the linear expansion coefficient of the polyimide resin layer and the adhesive strength between the polyimide resin layer and the conductor layer for laminates suitable for HDD suspension. However, it is becoming increasingly difficult for the technology herein disclosed alone to exercise impedance control to cope with higher capacity and greater data transmission rate of HDDs or with finer wring in the future. For example, a laminate comprising a 9 μm thick copper foil is described in the aforementioned WO98/08216; this copper foil is an electrodeposited copper foil whose tensile strength is less than 400 MPa and a laminate suitable for high-performance HDD suspension was difficult to prepare with the use of this copper foil. On the other hand, laminates prepared with the use of copper foils of low resistance, high conductance and high strength have been proposed to increase the data transmission rate; however, the truth is that the technology for manufacturing higher capacity HDDs requires miniaturization of a slider and the consequent reduction in fling height of a slider and the proposed laminates were not capable of satisfactorily controlling the spring characteristics necessary for execution of the technology.

### DISCLOSURE OF THE INVENTION

This invention comprises reducing the thickness of a copper foil to facilitate control of the flying height of a slider thereby increasing the degree of freedom of spring characteristic required for suspension and providing a substrate for HDD suspension which possesses a conductor layer of sufficient strength for forming a stable flying lead and is suitable for fabrication of fine wring of a higher level and an object of this invention is to provide a laminate for HDD suspension which is capable of attaining a high capacity hitherto unknown for HDD without adversely affecting the fabricability known thus far and a method for manufacturing the same.

This invention relates to a laminate for HDD suspension which is constituted of a stainless steel layer, a polyimide resin layer and a conductor layer and the conductor layer is made of a copper foil or a copper alloy foil with a thickness of 14 μm or less, a tensile strength of 400 MPa or more and a conductance of 65% or more.

Furthermore, this invention relates to a method for manufacturing a laminate for HDD suspension which comprises coating a stainless steel layer with a solution of polyimide resin, heat-treating the solution to form a polyimide resin layer, placing a rolled copper alloy foil with a thickness of 14 μm or less, a tensile strength of 500 MPa or more and a conductance of 65% or more on the polyimide resin layer and hot-pressing at a pressure of 1-20 MPa and a temperature of 280° C. or above thereby forming a laminate which is constituted of a stainless steel layer, a polyimide layer and a conductor layer.

A laminate for HDD suspension manufactured according to this invention (hereinafter refereed to also as a laminate) is constituted of a stainless steel layer, a polyimide resin layer and a conductor layer.

The stainless steel layer of this invention is not restricted, but SUS304 is preferable from the viewpoint of spring characteristics and dimensional stability and SUS304 that has been annealed at a temperature above 300° C. is particularly preferable. The thickness of stainless steel to be used is preferably in the range of 10-50 μm, more preferably in the range of 12-30 μm.

When the thickness of the stainless steel layer is less than 10 μm, spring characteristics capable of sufficiently controlling the flying height of a slider may not be secured. On the other hand, when the thickness exceeds 50 μm, the rigidity becomes excessively great and it may become difficult to keep the flying height of a slider to be mounted at a low level.

The polyimide resin constituting the polyamide layer in the laminate is a polymer containing an imide linkage in the backbone such as polyamides, polyamideimides and polyetherimides. The thickness of the polyimide resin layer is preferably in the range of 5-25 μm, more preferably in the range of 5-20 μm. When the polyimide resin layer is less than 5 μm in thickness, the layer may not sufficiently function as an insulating layer. On the other hand, when the thickness exceeds 25 μm, the step for etching the polyimide layer during the manufacture of suspension takes time, which may result in poor etching shape or in lowered productivity.

The polyimide resin layer may satisfactorily be a single layer, but the use of a plurality of polyimide resin layers is preferable here. In the case of a plurality of polyimide resin layers, polyimide resins used in the layers which are placed in contact with the conductor layer or the stainless steel layer preferably show good adhesiveness to the conductor layer or the stainless steel layer. Polyimide resins with a glass transition temperature of 300° C. or below are known to show good adhesiveness. Polyimide resins to be used in the intermediate layers not in contact with the conductor layer or the stainless steel layer are preferably those which show a small dimensional change in response to a temperature change or a linear expansion coefficient of 30×10⁻⁶/° C. or less, more preferably 20×10⁻⁶/° C. or less from the viewpoint of the dimensional stability of the resulting HDD suspension. In the cases where the polyimide resin layer is composed of three layers or more, it is advantageous to set the ratio of the thickness of the sum of two outermost layers (1) to the thickness of the intermediate layers (t) at a value in the range of 0.1-0.5 or T/t=0.1-0.5. In the case of a plurality of polyimide resin layers, it is also preferable to set the linear expansion coefficient of the total polyimide resin layers at or below 30×10⁻⁶/° C.

The conductor layer of this invention is composed of a copper foil or a copper alloy foil The copper alloy foil here refers to an alloy foil that contains copper as an indispensable ingredient and at least one kind of non-copper element such as chromium, zirconium, nickel silicon, zinc and beryllium and the foil has a copper content of 90 wt % or more. It is preferable to use a copper alloy foil with a copper content of 95 wt % or more. The thickness of a copper foil or a copper alloy foil constituting the conductor layer is required to be 14 μm or less and is preferably in the range of 7-14 μm. When a copper foil with a thickness in excess of 14 μm is used, the elasticity of the copper foil influences the flying height of a slider to a greater extent and this is undesirable from the viewpoint of fine positional accuracy.

As stated above, the conductor layer in the laminate of this invention needs to be thin and, at the same time, it needs to have a tensile strength of 400 MPa or more and a conductance of 65% or more. When a rolled copper alloy foil is used as the conductor layer, the tensile strength practically does not drop upon heating. When an electrodeposited copper foil is used, however, the tensile strength drops in some cases. It is therefore preferable to select for the conductor layer a copper foil or a copper alloy foil that shows a minimal change in tensile strength during hot pressing in the steps for manufacture of laminates. Concretely, it is preferable to use a copper foil or a copper alloy foil that shows a tensile strength of 400 MPa or more and a conductance of 65% or more after hot pressing at a pressure in the range of 1-20 MPa and at a temperature of 280° C. When the conductor layer has a tensile strength of less than 400 MPa, a flying lead to be formed does not have sufficient copper foil strength and wire breakage and other problems tend to occur. Moreover, when the conductance is less than 65%, noise generated by the copper foil resistor is given off as heat and, as a result, the impedance control becomes difficult and the tension rate becomes unsatisfactory. A rolled copper alloy foil with a tensile strength of 500 MPa or more and a conductance of 65% or more is particularly suitable for the conductor layer. The tensile strength and conductance of this invention are determined by the methods described in the accompanying examples.

A method for manufacturing a laminate of this invention will be described below.

The first step in the manufacture of a laminate is coating of a stainless steel layer or a substrate with a polyimide resin solution. The polyimide resin solution can be applied in a known method, normally with the use of an applicator. The polyimide resin solution here may be a solution of polyimide resin after completion of imidation, but it is preferable to coat the substrate with a solution of a polyimide resin precursor, remove some of the solvent from the solution by preliminary heating and finally complete the imidation of the precursor by a heat treatment. When the imidized resin is used, the heat treatment for imidation is naturally omitted. Where polyimide resins are used in two layers or more, the aforementioned coating and heating are repeated to form a multilayer structure.

After formation of a polyimide resin layer in the aforementioned manner, a copper foil or a copper alloy foil that has a thickness of 14 μm or less, preferably 7-14 μm, a tensile strength of 400 MPa or more and a conductance of 65% or more is placed on the polyimide resin layer and the two are hot-pressed at 280° C. or above to give a laminate constituted of a stainless steel layer, a polyimide layer and a conductor layer. Since some of electrodeposited copper foils deteriorate in tensile strength on heating, it is preferable to use a rolled copper alloy foil having a tensile strength of 500 MPa or more.

The hot pressing is preferably performed at a pressure of 1-50 MPa, more preferably 1-20 MPa, for a period of 5-30 minutes while keeping the temperature of a hot press at 280° C., or above, preferably in the range of 300-400° C. When the hot pressing is performed outside the aforementioned range, the laminate undergoes undesirable changes in shape such as warping and suffers deterioration in peel strength.

The thickness of constituent layer in the laminate is preferably 12-30 μm for the stainless steel layer, 5-20 μm for the polyimide layer and 7-14 μm for the conductor layer while the total thickness of the laminate is in the range of 20-50 μm.

Stainless steel polyimide resin and a conductor useful for the earlier-mentioned laminates can be used in the aforementioned method for manufacturing and, likewise, they can be used in the preferred embodiments of & invention. As for the conductor, electrodeposited copper foils in common use tend to cause warping of the laminate by irreversible elongation at a temperature above 300° C. and it is preferable to use a rolled copper foil or a rolled copper alloy foil to stabilize the laminate against warping.

### PREFERRED EMBODIMENTS OF THE INVENTION

This invention will be described concretely with reference to the examples and comparative examples. A variety of properties in the examples are evaluated in accordance with the methods described below. The polyimide samples used for the tests are those which have undergone sufficient imidation.

(Measurement of Peel Strength)

To determine the adhesive strength between a metal foil and a polyimide resin, a layer of polymide resin was formed on a stainless steel foil, a copper foil was hot-pressed to the polyimide resin layer and the resulting laminate having metals on both sides was fabricated into a prescribed shape to give a test sample with a wiring width of ⅛ inch. The SUS foil side or the copper foil side of the sample was attached to a fixed plate and, with the aid of a tensile tester (Strograph M1, available from Toyo Seiki Co., Ltd), each metal foil was pulled off in the direction of 90° to measure the peel strength.

(Measurement of Warpage)

A laminate sample was fabricated into a disk with a diameter of 65 mm left standing at 23° C. and a humidity of 50% for 24 hours, placed on a desk and the portion which showed the largest warpage was measured with calipers.

(Measurement of Conductance)

The conductance was measured in conformity with JIS H0505.

(Measurement of Strength of Copper Foil)

The measurement was made in conformity with IPC-TM-650. A strip, 12.7 mm in width and 254 mm in length, was cut from a laminate and, with the aid of a tensile tester (Strograph-R1, available from Toyo Seiki Co., Ltd), it was tested at a crosshead speed of 50 mm/min with the distance between chucks set at 50.8 mm, the displacement (elongation) during the tensile test was obtained and the 0.2% A proof strength was calculated from the stress-strain curve.

(Measurement of Linear Thermal Expansion Coefficient)

The linear thermal expansion coefficient was measured with the use of a thermomechanical analyzer (available from Seiko Instruments Inc.) by heating the sample at a rate of 20° C./min to 255° C., keeping it at this temperature for 10 minutes and then cooling it at a constant rate of 5° C./min. The average thermal expansion coefficient (linear thermal expansion coefficient) between 240° C. and 100° C. during cooling was calculated.

The abbreviations of the chemical compounds to be used in the examples are as follows.
BPDA: 3,3′,4,4′-Biphenyltetracarboxylic add dianhydride
DADMB: 4,4′-Diamho-2,2′-dimethylbiphenyl
BAPP: 2,2′-Bis[4-(4-aminophenoxy)phenyl]propane
DMAc: N,N-Dimethylacetamide

### SYNTHETIC EXAMPLE 1

For the synthesis of a polyimide resin of low thermal expansion with a thermal expansion coefficient of 30×10⁻⁶/K or less, 9.0 moles of DADMB was weighed out and dissolved in 25.5 kg of DMAc with stirring in a 40-L planetary mixer, 8.9 moles of BPDA was added and the mixture was allowed to polymerize at room temperature with stirring for 3 hours to give a viscous solution of polyamide precursor. A Polyimide precursor A showed a linear expansion coefficient of 13×10⁻⁶/K after imidation.

### SYNTHETIC EXAMPLE 2

For the synthesis of a polyimide resin with a glass transition temperature of 300° C. or below, 6.3 moles of DADMB was weighed out and dissolved in 25.5 kg of DMAc with stirring in a 40-L planetary mixer, 6.4 moles of BPDA was added and the mixture was allowed to polymerize at room temperature with stirring for 3 hours to give a viscous solution of polyimide precursor B. The glass transition temperature of polyimide precursor B was 225° C. after imidation as determined with the aid of an instrument for measuring dynamic viscoelasticity.

### EXAMPLE 1

A solution of polyimide precursor B obtained in Synthetic Example 2 was applied to a stainless steel foil (SUS304, tension-annealed and 20 μm thick; available from Nippon Steel Corporation) to a thickness after curing of 1 μm and dried at 110° C. for 3 minutes, a solution of polyimide precursor A obtained in Synthetic Example 1 was applied to the surface of dried polyimide precursor B to a thickness after curing of 7.5 μm and dried at 110° C. for 10 minutes, and then a solution of polyimide precursor B obtained in Synthetic Example 2 was applied to the surface of dried polyimide precursor A to a thickness after curing of 1.5 μm and dried at 110° C. for 3 minutes; the polyimide precursor layers were imidized in the range of 130-360° C. in several steps, each step for 3 minutes, to give a laminate consisting of a stainless steel layer and 10 μm thick polyimide layers. The polyimide resin in the first layer was made identical with that in the third layer.

A rolled copper alloy foil (NK-120 with a thickness of 12 μm, available from Japan Energy Corporation) shown in Table 1 was placed on the aforementioned laminate and hot-pressed in a vacuum press at 15 MPa and 320° C. for 20 minutes to give a target laminate. The properties of this laminate were evaluated and, as shown in Table 1, the laminate was a material of high strength and high conductance fully satisfying the basic requirements for a substrate of suspension.

### EXAMPLE 2

A laminate consisting of a stainless steel layer and 10 μm thick polyimide resin layers was prepared as in Example 1.

A rolled copper alloy foil (NK-120 with a thickness of 8 μm, available from Japan Energy Corporation) was placed on the aforementioned laminate and hot-pressed in a vacuum press at 15 MPa and 320° C. for 20 minutes to give a target laminate. The properties of the laminate were evaluated and, as shown in Table 1, the laminate was a material of high strength and high conductance fully satisfying the basic requirements for a substrate of suspension.

### COMPARATIVE EXAMPLE 1

A laminate consisting of a stainless steel layer and 10 μm thick polyimide resin layers was prepared as in Example 1.

A rolled copper alloy foil (C7025 with a thickness of 18 μm, available from Olin) was placed on the aforementioned laminate and hot-pressed in a vacuum press at 15 MPa and 320° C. for 20 minutes to give a target laminate. The properties of the laminate were evaluated and, as shown in Table 1, the laminate has satisfactory basic properties required for a substrate of suspension, but it would find difficulty in meeting the technical demands in the future because its low conductance makes it difficult to exercise impedance control and its greater foil thickness generates excessive elasticity to interfere with the control of the flying height of a slider.

### COMPARATIVE EXAMPLE 2

A laminate consisting of a stainless steel layer and 10 μm thick polyimide resin layers was prepared as in Example 1.

A rolled copper alloy foil (NK-120 with a thickness of 18 μm, available from Japan Energy Corporation) was placed on the aforementioned laminate and hot-pressed in a vacuum press at 15 MPa and 320° C. for 20 minutes to give a target laminate.

The properties of the laminate were evaluated and, as shown in Table 1, the laminate has satisfactory basic properties required for a substrate of suspension; it has a high conductance to facilitate impedance control but it would find difficulty in meeting the technical demands in the future as its greater foil thickness restricts the flying height of a slider.

### COMPARATIVE EXAMPLE 3

A laminate consisting of a stainless steel layer and 10 μm thick polyimide resin layers was prepared as in Example 1.

An electrodeposited copper foil (B WS with a thickness of 12 μm, available from Furukawa Circuit Foil Co., Ltd.) was placed on the aforementioned laminate and hot-pressed in a vacuum press at 15 MPa and 320° C. for 20 minutes to give a target laminate. The properties of the laminate were evaluated and, as shown in Table 1, the laminate warped excessively and was confirmed to be unsuitable for a substrate of suspension

The laminates of Examples 1 and 2 and Comparative Examples 1 through 3 were evaluated and the results are shown in Table 1.

None of the laminates showed abnormalities such as blistering and peeling when tested for heat resistance in an oven at 300° C. for 1 hour. The linear expansion coefficients of the polyimide films obtained by removing the metal foils by etching are shown in Table 1.

TABLE 1

| | | | Comp. | Comp. | Comp. |
|---|---|---|---|---|---|
| | Example | Example | example | example | example |
| | 1 | 2 | 1 | 2 | 3 |
| Thickness of cop- | 12 | 8 | 18 | 18 | 12 |
| per foil μm | | | | | |
| Conductance % | 79 | 78 | 47 | 76 | 100 |
| Strength of cop- | 556 | 572 | 740 | 584 | 332 |
| per foil MPa | | | | | |
| Thermal expansion | 22.3 | 22.3 | 22.3 | 22.3 | 22.3 |
| coefficient of | | | | | |
| polyimide ppm/K | | | | | |
| Peel strength be- | 1.8 | 1.8 | 2.2 | 2.0 | 2.0 |
| tween stainless | | | | | |
| steel and poly- | | | | | |
| imide kN/m | | | | | |
| Peel strength be- | 2.6 | 2.0 | 2.5 | 2.3 | 1.2 |
| tween copper foil | | | | | |
| and polyimide kN/m | | | | | |
| Warpage mm | 1.8 | 1.6 | 2.8 | 1.3 | 21.5 |

### INDUSTRIAL APPLICABILITY

According to this invention, it is possible to provide a substrate for HDD suspension which is capable of improving the positional accuracy of the suspension essential to technical achievement of higher capacity of HDDs by reducing the thickness of copper foils to facilitate control of the spring characteristics for adjustment of the flying height of a slider of the suspension, enhancing the conductance to improve impedance control reduce loss of electrical signals and increase the transmission rate and maintaining high strength to facilitate fabrication of shape such as a flying lead while providing sufficient wiring strength during fabrication and practical use to eliminate problems such as wire bread.

What is claimed is:

1) A laminate for HDD suspension comprises a stainless steel layer, a polyimide resin layer and a conductor layer wherein said conductor layer is a copper foil or a copper alloy foil having a thickness of 14 μm or less, a tensile strength of 400 MPa or more and a conductance of 65% or more.

2) A laminate for HDD suspension as described in claim 1 wherein the thickness of the stainless steel layer is in the range of 12-30 μm.

3) A laminate for HDD suspension as described in claim 1 wherein the thickness of the polyimide resin layer is in the range of 5-20 μm.

4) A laminate for HDD suspension as descried in claim 1 wherein the conductor layer is a rolled copper alloy foil having a tensile strength of 500 MPa or more and a conductance of 65% or more.

5) A laminate for HDD suspension as described in claim 1 wherein said laminate is constituted of a stainless steel layer, a polyimide resin layer and a conductor layer, the conductor layer is a copper foil or a copper alloy foil having a thickness of 7-14 μm, a tensile strength of 500 MPa or more and a conductance of 65% or more, the stainless steel layer has a thickness in the range of 12-30 μm, the polyimide resin layer has a thickness in the range of 5-20 μm and the total thickness is in the range of 20-50 μm.

6) A method for manufacturing a laminate for HDD suspension which comprises applying a solution of a polyimide resin or a precursor thereof to a stainless steel layer, giving a heat treatment to form a polyimide resin layer, placing a rolled copper alloy foil having a thickness of 14 μm or less, a tensile strength of 500 MPa or more and a conductance of 65% or more on the aforementioned polyimide resin layer and hot-pressing at 1-20 MPa and 280° C. or above to give a laminate constituted of a stainless steel layer, a polyimide resin layer and a conductor layer.
